(19) United States
(12) Patent Application Publication
(10) Pub. No.: US 2025/0207927 A1
(43) Pub. Date: Jun. 26, 2025

(54) METHOD, APPARATUS, AND SYSTEM OF PROBE VEHICLE ANALYSIS ACROSS TRAVEL ZONES

(71) Applicant: HERE Global B.V., Eindhoven (NL)

(72) Inventors: Jingwei XU, Buffalo Grove, IL (US); Yuxin GUAN, Chicago, IL (US); Bruce BERNHARDT, Wauconda, IL (US); Weimin HUANG, Chicago, IL (US)

(21) Appl. No.: 18/392,843

(22) Filed: Dec. 21, 2023

(51) Int. Cl. G01C 21/34; G01C 21/00; G01C 21/32

(52) U.S. Cl. CPC G01C 21/3461; G01C 21/32; G01C 21/3476; G01C 21/3492; G01C 21/3841; G01C 21/3881

(57) ABSTRACT

An approach is provided for probe vehicle analysis across travel zones. The approach involves, for example, determining probe data, sensor data, or a combination thereof collected from a plurality of sensors of a plurality of probe vehicles traveling in a geographic area of interest. The approach also involves for each probe vehicle of the plurality of probe vehicles, determining a vehicle attribute and a vehicle path for each probe vehicle from the probe data, the sensor data, or a combination thereof, and determining a start travel zone and an end travel zone of the vehicle path for each probe vehicle. The approach further involves processing the vehicle path for each probe vehicle to determine trip data crossing travel zones based on the start travel zone and the end travel zone. The approach further involves providing the trip data as an output based on the vehicle attribute.

### BACKGROUND

Providing accurate map and traffic data is a key function for mapping service providers. One approach to map making relies on collecting probe data over a large geographic area. However, such scalable map creation over a large geographic generally requires efficient probe data processing with algorithms adapted for distributed computing environment. As a result, mapping service providers face significant technical challenges with respect to subdividing the large geographic areas into travel zones for processing and analysis of probe data.

### SOME EXAMPLE EMBODIMENTS

Therefore, there is a need for an approach for probe vehicle analysis across travel zones.

According to one embodiment, a method comprises determining probe data, sensor data, or a combination thereof collected from a plurality of sensors of a plurality of probe vehicles traveling in a geographic area of interest. The method also comprises for each probe vehicle of the plurality of probe vehicles, determining a vehicle attribute and a vehicle path for each probe vehicle from the probe data, the sensor data, or a combination thereof, and determining a start travel zone and an end travel zone of the vehicle path for each probe vehicle. The method further comprises processing the vehicle path for each probe vehicle to determine trip data crossing travel zones based on the start travel zone and the end travel zone. The method further comprises providing the trip data as an output based on the vehicle attribute.

According to another embodiment, an apparatus comprises at least one processor, and at least one memory including computer program code for one or more computer programs, the at least one memory and the computer program code configured to, with the at least one processor, cause, at least in part, the apparatus to determine probe data, sensor data, or a combination thereof collected from a plurality of sensors of a plurality of probe vehicles traveling in a geographic area of interest. The apparatus is also caused to determine, for each probe vehicle of the plurality of probe vehicles, a vehicle attribute and a vehicle path for each probe vehicle from the probe data, the sensor data, or a combination thereof, and to determine a start travel zone and an end travel zone of the vehicle path for each probe vehicle. The apparatus is further caused to process the vehicle path for each probe vehicle to determine trip data crossing travel zones based on the start travel zone and the end travel zone. The apparatus is further caused to provide the trip data as an output based on the vehicle attribute.

According to another embodiment, a non-transitory computer-readable storage medium carries one or more sequences of one or more instructions which, when executed by one or more processors, cause, at least in part, an apparatus to determine probe data, sensor data, or a combination thereof collected from a plurality of sensors of a plurality of probe vehicles traveling in a geographic area of interest. The apparatus is also caused to determine, for each probe vehicle of the plurality of probe vehicles, a vehicle attribute and a vehicle path for each probe vehicle from the probe data, the sensor data, or a combination thereof, and to determine a start travel zone and an end travel zone of the vehicle path for each probe vehicle. The apparatus is further caused to process the vehicle path for each probe vehicle to determine trip data crossing travel zones based on the start travel zone and the end travel zone. The apparatus is further caused to provide the trip data as an output based on the vehicle attribute.

According to another embodiment, an apparatus comprises means for determining probe data, sensor data, or a combination thereof collected from a plurality of sensors of a plurality of probe vehicles traveling in a geographic area of interest. The apparatus also comprises means for determining, for each probe vehicle of the plurality of probe vehicles, a vehicle attribute and a vehicle path for each probe vehicle from the probe data, the sensor data, or a combination thereof, and means for determining a start travel zone and an end travel zone of the vehicle path for each probe vehicle. The apparatus further comprises means for processing the vehicle path for each probe vehicle to determine trip data crossing travel zones based on the start travel zone and the end travel zone. The apparatus further comprises means for providing the trip data as an output based on the vehicle attribute.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of probe vehicle analysis across travel zones, according to one example embodiment;

FIG. 2 is a diagram of a hierarchy of geographic entities, according to one example embodiment;

FIG. 3 is a diagram illustrating a data pipeline for providing probe vehicle analysis across travel zones, according to one embodiment;

FIG. 4 is a diagram of a mapping platform for providing probe vehicle analysis across travel zones, according to one example embodiment;

FIG. 5 is a flowchart of a process for providing probe vehicle analysis across travel zones, according to one embodiment;

FIG. 6 is a diagram of an example trip analysis between travel zones, according to one example embodiment;

FIG. 7 is a diagram of trip data for a geographic entity, according to one example embodiment;

FIG. 8 is a diagram of linking mapping between travel zones and map tiles, according to one example embodiment;

FIG. 9 is a diagram of a geographic database, according to one example embodiment;

FIG. 10 is a diagram of hardware that can be used to implement an example embodiment;

FIG. 11 is a diagram of a chip set that can be used to implement an example embodiment; and

FIG. 12 is a diagram of a mobile terminal (e.g., handset or vehicle or part thereof) that can be used to implement an example embodiment.

### DESCRIPTION OF SOME EMBODIMENTS

Examples of a method, apparatus, and computer program for providing probe vehicle analysis across travel zones are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

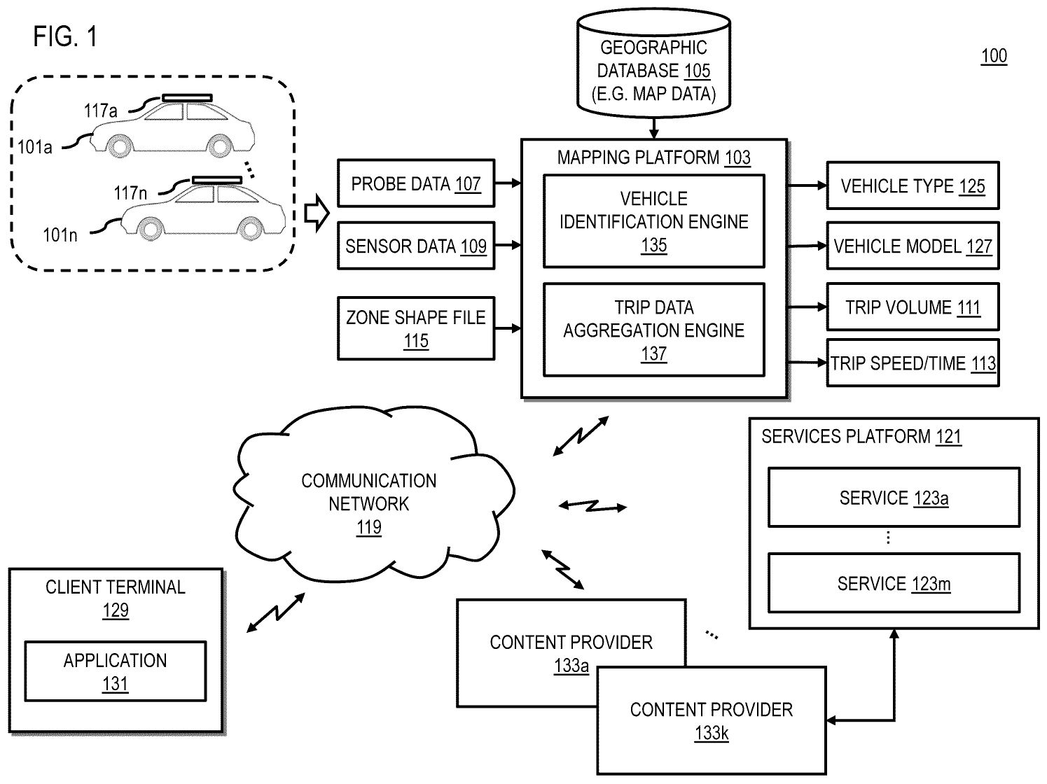

FIG. 1 is a diagram of a system 100 capable of probe vehicle analysis across travel zones, according to one example embodiment. In recent years, there has been significant development in the autonomous vehicle and electric vehicle sectors, supported by governments and automotive original equipment manufacturers (OEMs). Major countries such as the United States, China, and Germany have witnessed substantial growth in the sale of vehicles in both markets, and this growth is expected to continue in the coming decades. Combining autonomous driving technology with electric vehicle technology is likely to drive the fast-growing market of autonomous electric vehicles (AEVs) (e.g., vehicles 101a-101n, also collectively referred to as vehicles 101).

There is an expectation that electric vehicles (EVs) and autonomous electric vehicles (AEVs) will play a significant role in the commercial vehicle sector, particularly in fleet vehicles, to improve transportation logistics efficiency. Prominent OEMs are actively engaged in the development of their autonomous electric vehicles, both for commercial and personal use. This trend introduces technical challenges related to the integration of autonomous technologies into commercial fleets, demanding sophisticated systems for data collection, real-time analysis, and route optimization to enhance overall transportation efficiency that can scale with volume.

Transportation and logistics (T&L) involve delivering products from suppliers to customers, with efficiency and optimal cost being metrics for evaluating logistics management performance. Logistics firms with their own fleets (e.g., vehicles 101) typically use route plans that start and end at the same location to minimize vehicle and personnel repositioning. However, the increasing complexity of developing efficient routes, especially with multiple customer deliveries and pickups, poses technical challenges. Real-time monitoring and adjustments through modeling in the transportation network are critical, requiring advanced data processing and analysis capabilities to maintain efficient and economic route planning in dynamic environments.

Transportation's pivotal role in logistics management necessitates accurate estimation of production delivery times. Mapping service providers (e.g., operators of mapping platform 103), providing high-resolution maps (e.g., digital map data of geographic database 105), real-time traffic, weather information, and traffic light signal phase and timing (SPaT) data (e.g., also stored in and provided by geographic database 105), contribute to estimating precise product delivery times. The technical challenge lies in integrating and processing diverse data sources (e.g., probe data 107, sensor data 109) in real-time to provide accurate and timely information (e.g., trip data such as but not limited to trip volume 111, trip speed/time 113, and/or the like) for logistics planning. Achieving this requires advanced algorithms and systems capable of handling the intricacies of dynamic transportation scenarios.

Traffic Analysis Zones (TAZ) (or more generally travel zones) are geographic units (e.g., as defined in the zone shape file 115—providing representations of the boundaries of travel zones and/or their attributes) used in transportation planning and modeling to analyze and assess travel patterns within a given area. It is noted that in the various embodiments described herein, the term TAZ is used as an example of the more general term travel zone. In one embodiment, the term travel zone also includes geographic areas or zones that are constructed or defined in ways other than a TAZ. For example, a travel zone can be any designated or defined geographic area. In other words, the travel zones can correspond to any subdivided geographic areas/zones, e.g., including any customer defined geographic area(s) specified or otherwise designated by a user of the system 100, any geographic areas defined by a governmental/regulatory authority, and/or the like. In some embodiments, the custom designated geographic area can be associated with or otherwise defined by the geographic boundaries of a point of interest (POI) such as but not limited to those stored in the geographic database 105. In either case, anywhere the term TAZ is used in the various embodiments described herein, it is contemplated that the term travel zone is equally applicable and vice versa.

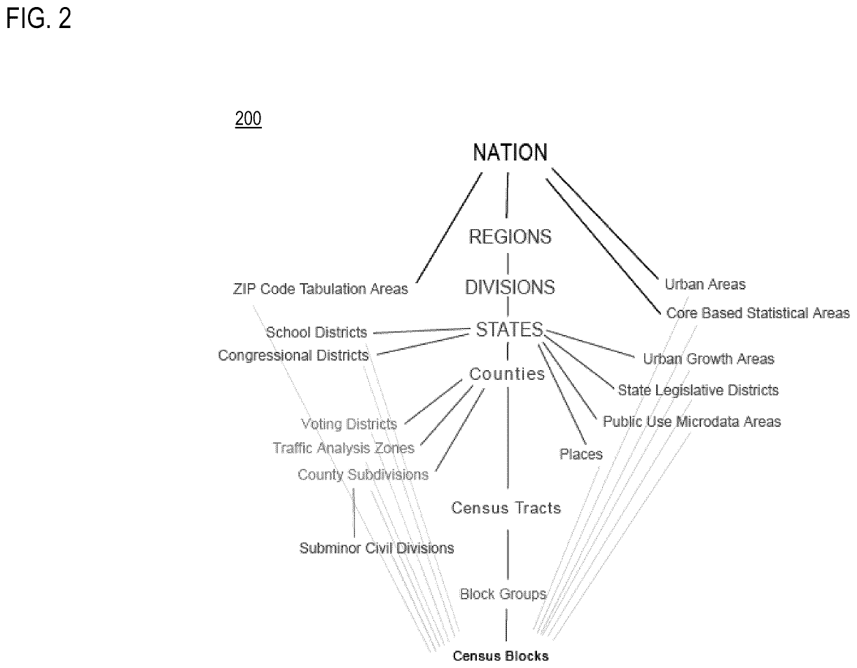

These zones can be used for understanding the movement of vehicles 101 (e.g., commercial or personal) and associated people and goods, and they serve as building blocks for creating comprehensive transportation plans. In one embodiment, a TAZ or travel zone is a delineated area within a geographical region, usually defined based on census block information. FIG. 2 is a diagram of a hierarchy 200 of geographic entities from which travel zones can be derived, according to one example embodiment. As shown, these zones can vary in size, ranging from large areas in suburban regions to as small as city blocks or individual buildings in urban centers. A TAZ or travel zone serves as a fundamental unit for aggregating and analyzing transportation-related data in planning models.

The primary purpose of a TAZ or travel zone is to facilitate the analysis of travel behavior, transportation demand, and related socio-economic factors within a specific area. A TAZ or travel zone allows planners and analysts to break down a larger geographic region into manageable units for detailed study, enabling a more granular understanding of transportation dynamics. By way of example, a TAZ is typically constructed based on census block information, and each zone is associated with specific socio-economic attributes. Commonly considered factors include the number of households, household income, employment statistics, and demographic data. These attributes help planners understand the characteristics of each zone and make informed decisions about transportation infrastructure and services.

In transportation planning models, a TAZ or travel zone serves as a fundamental input. These models utilize TAZs to estimate and predict travel demand, traffic flow, and the impact of various transportation scenarios. By analyzing TAZ trip and related data, planners can make informed decisions about infrastructure development, public transit routes, and other interventions to improve transportation efficiency.

In one embodiment, a TAZ or travel zone is not static and can evolve over time. Changes in demographics, land use, and transportation infrastructure may lead to the redefinition or adjustment of TAZ boundaries. This adaptability ensures that planning models stay relevant and accurate in reflecting the changing dynamics of urban and suburban environments. This adaptability also creates technical challenges with respect to monitoring and updating travel zones as they evolve.

A TAZ or travel zone is often integrated with various data sources, including traffic counts, survey data, and now, with advancements, probe data 107 and sensor data 109 (e.g., real-time and/or batch/historical data). This integration enhances the accuracy and reliability of transportation planning models, providing a comprehensive view of travel patterns and demands. By way of example, probe data 107 involves continuously updated information collected from probes or devices installed on vehicles 101. These devices, equipped with sensors 117a-117n (also collectively referred to as sensors 117) and communication technology (e.g., for communicating over a communication network 119), provide dynamic insights into factors like location, speed, and acceleration. Collected from a diverse array of vehicles 101, this data is instrumental for navigation services (e.g., provided by the mapping platform 103, services platform 121, one or more services 123a-123m—also collectively referred to as services 123, and/or any other component of the system 100), traffic flow monitoring, and making real-time adjustments to optimize routing/traffic management strategies.

However, collecting probe data 107 and/or sensor data 109 from vehicles 101 or other probes across a wide geographic area to process trip data across multiple travel zones presents several technical challenges. The sheer volume of data generated from a large number of vehicles 101 poses a significant hurdle in terms of scalability, requiring robust systems for efficient storage and processing. Ensuring the accuracy and consistency of the collected data is crucial for reliable trip analysis, and the real-time processing of this information is necessary for immediate decision-making in transportation planning. Balancing the need for detailed vehicle data with privacy concerns is also an ongoing challenge, demanding careful data anonymization and security measures. Integrating data from diverse sources and sensors, establishing a reliable communication infrastructure, and addressing the lack of standardized protocols can further complicate the process. Quality assurance for the collected data, mitigation of security risks, and minimizing the impact on vehicle power consumption are additional considerations. Successfully addressing these challenges involves the adoption of advanced technologies, effective data management strategies, and collaborative efforts among stakeholders to ensure the seamless collection and processing of probe and sensor data for transportation planning purposes.

In addition, with the significant growth in Electric Vehicles (EV) and autonomous driving trends in recent years, there arises a challenge in reidentifying travel zones or TAZs to account for the changes in vehicle demographics. Exploring how travel zones can contribute to the community and T&L becomes a significant technical challenge in light of these evolving trends and growing volumes of data to process.

To address these technical challenges, the system 100 introduces a capability to target the use of the mapping platform 103 for cross travel zone/TAZ trip analysis, including travel volume and time categorized by vehicle attributes such as but not limited to (autonomous vehicle (AV), EV, or traditional fuel types) for transportation and logistics (T&L), transportation planning, and future TAZ production planning. TAZ, an essential geographic unit in travel demand models, faces challenges in adapting to the growing trends in EVs and autonomous driving, necessitating re-identification to benefit communities and T&L. In one embodiment, the system 100 leverages HERE MAP data, probe data, and trips data to analyze travel modes categorized by vehicle type 125 (AV, EV, Gas, Diesel) and vehicle make/model 127 (e.g., luxury sedans, electric cars) to support T&L, TAZ planning, community growth, and more.

In one embodiment, the system 100 models the use map data (e.g., geographic database 105), probe data 107/sensor data 109, and derived trip data with travel mode determined for trips analysis by vehicle attribute such as but not limited to vehicle type (e.g., AV, EV, Gas, Diesel, etc.), vehicle make (e.g., vehicle OEM manufacturer), etc. to support T&L, TAZ planning, community growth, etc. In one embodiment, the system 100 performs a process comprising the steps of: 1) retrieving map attributes (e.g., map data of the geographic database 105), probe data 107, and/or sensor data 109; 2) for each probe vehicle in the probe data 107, determine its vehicle attribute(s) such as but not limited to vehicle type 125 (e.g., AV, EV, GAS, Diesel, etc.) and/or its vehicle make and model 127, etc. (e.g., via a vehicle identification engine 135 of the mapping platform 103); 3) map match the vehicle path to road segment, e.g., on a lane level; 4) map match the vehicle path start and end point to respective travel zones/TAZs; 5) generate traffic flow and volume data from the determined data; 6) generate trip data crossing TAZ zones (e.g., trip volume 111, trip speed/time 113, etc.) (e.g., via a trip data aggregation engine 137 of the mapping platform 103); and 7) deliver the analysis results (e.g., trip volume 111, trip speed/time 113, etc.) for between any two zones or among multiple travel zones/TAZs.

Analyzing trip data within Traffic Analysis Zones (TAZ) and identifying the start and end TAZs (e.g., according to the various embodiments described herein) offers numerous advantages in the realm of transportation planning. By delving into travel patterns at a granular level within specific TAZs, planners gain a nuanced understanding of local demands and preferences. This knowledge proves invaluable for optimizing route planning, minimizing travel time, fuel consumption, and associated costs. Furthermore, it enables targeted infrastructure development, allowing planners to prioritize investments in transportation infrastructure based on the specific needs of different TAZs. The insights derived from this analysis facilitate the implementation of effective Transportation Demand Management (TDM) strategies, such as promoting alternative transportation modes and optimizing public transit routes. Start and end TAZ information is instrumental in tailoring public transit services to align with the travel patterns and demands of specific zones. Moreover, TAZ-based trip data analysis aids in identifying congestion-prone areas, devising congestion mitigation strategies, and enhancing overall traffic flow efficiency. Urban planners benefit from TAZ insights in making informed land-use decisions, strategically locating commercial centers, residential areas, and recreational spaces to optimize accessibility. Overall, leveraging TAZ-based trip data supports data-driven decision-making, allowing planners to adapt policies and interventions based on the unique characteristics and demands of different geographic zones.

In addition, analyzing trip data within Traffic Analysis Zones (TAZ) and identifying start and end TAZs (e.g., according to the various embodiment described herein) also provides distinct advantages in terms of the underlying compute infrastructure. A scalable computing environment is crucial for efficient processing and analysis of the increasing volume of data associated with numerous TAZs and detailed trip information. Real-time processing capabilities are essential, ensuring that trip data can be analyzed promptly for timely decision-making, and parallel processing enhances efficiency by simultaneously handling data from different TAZs. The underlying compute infrastructure should support seamless data integration, accommodating diverse sources such as traffic sensors and mapping services. Furthermore, advanced analytics, involving complex algorithms and machine learning, require a robust computing environment with ample computational power. Given the geographical nature of TAZs, the compute infrastructure must facilitate geospatial analysis for tasks like route optimization and spatial visualization. Adequate storage capacity is vital to manage the growing volume of trip data, and stringent security measures, including encryption and access controls, safeguard sensitive information. The adaptability and flexibility of the compute infrastructure are essential for accommodating changes in data formats, sources, and analysis requirements, ensuring its relevance in the dynamic field of transportation planning. Overall, a well-designed compute infrastructure is fundamental for harnessing the advantages of TAZ-based trip data analysis and making informed decisions in the evolving landscape of transportation systems.

In one embodiment, zones are constructed by census block information or by another other designated geographic entity (e.g., example geographic entity at any hierarchical level as illustrated in FIG. 2). Typically, these blocks are used in transportation models by providing socio-economic data. States differ in the socio-economic data that they attribute to the zones. Most often the critical information is the number of automobiles per household, household income, and employment within these zones. This information helps to further the understanding of trips that are produced and attracted within the zone. Again, these zones can change or be altered as mentioned. This is done typically to eliminate unneeded areas to limit the computational burden.

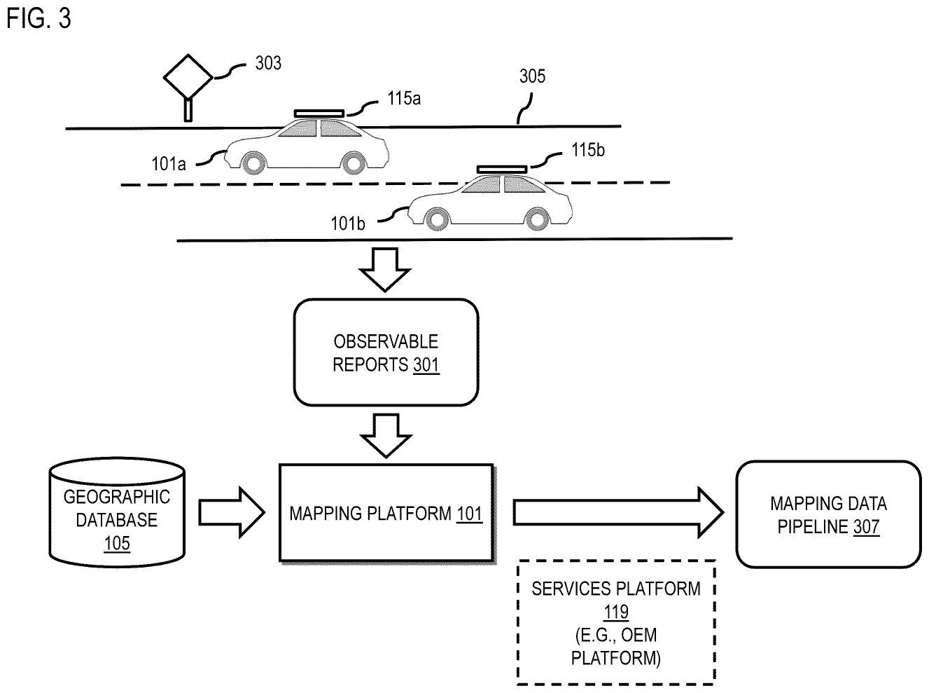

Mapping services providers via the mapping platform 103 are capable of collecting vehicle probe data 107 and/or vehicle sensor data 109. FIG. 3 is a diagram illustrating a data pipeline (e.g., real-time or batch processing pipeline) for collecting data to provide probe vehicle analysis across travel zones, according to one example embodiment. In one embodiment, the process for probe vehicle analysis across travel zones can be performed as part of an automated and/or manual mapping pipeline as shown in FIG. 3. Automated refers, for instance, to operating the pipeline without manual intervention in all or a portion of the pipeline from data ingestion to output of the measured error for the relative position data. As shown, the mapping platform 103 receives observable reports 301 as the vehicles 101a/101b travel on a road 303. In one embodiment, each observable report 301 includes probe and sensor data reports. The probe data for instance can indicate a location of the vehicle 101 along with a time stamp and probe identifier, and the sensor report can include sensor readings taken at the corresponding location. The sensor reading, for instance, include sensor data indicating a detected road objects 303—e.g., point features such as signs and/or the like. It is also contemplated that the sensor data can be any output of any sensor 117 equipped on the vehicle 101.

The mapping platform 103 aggregates and analyzes the observable reports 301 (e.g., from one or more vehicles 101) to determine trip data across travel zones, according to the various embodiments described herein. In one embodiment, the determined trip data can be used for analysis such as but not limited to traffic flow and/or traffic volume analysis between or among travel zones. The mapping data pipeline 307, for instance, can the trip data across travel zones to generate digital map data or real-time data of the geographic database 105 and/or to provide location-based services (e.g., to a vehicle 101 or other client terminal 129 executing an application 131). The mapping data pipeline 307, for instance, can further process, verify, format, etc. the trip data and/or any other data derived therefrom before publication, use, or updating of the digital map data of the geographic database 105.

In one embodiment, the mapping platform 103 can use any architecture for transmitting the observable reports 301, trip data across travel zones, and/or related information to the end user devices (e.g., the vehicle 101, client terminal 129 executing a client application 131, etc.) over a communication network 119. In one embodiment, the mapping platform 103 can also transmit or publish the intersection data to a third-party services platform 121, any services 123 of the services platform 121, one or more content providers 133a-133k (also collectively referred to as content providers 133). When performing direct publishing, the transmission of the probe data, sensor data, trip data, etc. is performed over the communication network 119 between the mapping platform 103 and one or more user devices (e.g., the vehicles 101, client terminal 129, etc.) directly. When publishing via a third-party, the transmission of the probe data, sensor data, trip data, etc. is performed over the communication network 119 between the mapping platform 103 and a third-party provider such as the services platform 121 (e.g., a vehicle OEM platform), services 123, and/or content providers 133.

Also, the mapping platform 103 is capable of detecting and reporting the road segment traffic flow information (e.g., trip speed/time 113), volume information (e.g., trip volume 111), and incident information as the services to be used for highly automated driving on L3, L4, and even further for L5 level autonomous driving for multiple purposes like road safety enhancement and routing navigation improvement. For example, the Society of Automotive Engineers (SAE) has established a classification system to categorize the different levels of automation in vehicles. This classification, known as the SAE J3016 standard, defines six levels, ranging from Level 0 (No Automation) to Level 5 (Full Automation).

Each level represents a different degree of automation, indicating the extent to which a vehicle can perform driving tasks without human intervention. At Level 0 (No Automation), there is no automation, and the human driver is responsible for all aspects of driving. The vehicle may have some basic driver assistance features, but they do not constitute automation. Level 1 (Driver Assistance) involves driver assistance systems that can handle either steering or acceleration/deceleration tasks. However, the human driver must remain engaged and monitor the environment, as these systems are not fully autonomous. At Level 2 (Partial Automation), the vehicle can manage both steering and acceleration/deceleration simultaneously under certain conditions. The driver must remain vigilant and be ready to take control when necessary. Examples include advanced adaptive cruise control and lane-keeping assistance. Level 3 (Conditional Automation) vehicles can perform most driving tasks autonomously under specific conditions, such as highway driving. The driver can disengage from active control, allowing the system to operate independently. However, the driver must be ready to take over if the system encounters a situation it cannot handle. At Level 4 (High Automation), the vehicle is capable of full autonomy in specific scenarios or environments, such as urban areas or dedicated lanes. The system can manage all aspects of driving without human intervention within these predefined conditions. Outside of these scenarios, human intervention may be required. Level 5 (Full Automation) represents full automation, where the vehicle can handle all driving tasks in all conditions without human intervention. Level 5 vehicles do not require a steering wheel or pedals, as there is no need for human control. In one embodiment, the level of autonomy can be another vehicle attribute, and the system 100 can determine trip data across travel zones based on the different levels of vehicle autonomy.

In summary, partitioning probe and sensor data based on travel zones or Traffic Analysis Zones (TAZ) delivers notable technical benefits that enhance the underlying compute infrastructure. By organizing data into specific partitions corresponding to individual TAZs, the system achieves more efficient processing. This targeted approach enables parallelization of data analysis, allowing different compute resources to concurrently handle data from distinct travel zones. The optimized resource allocation ensures that each zone receives the necessary computing power, contributing to a scalable and adaptable infrastructure. For real-time processing, partitioning by travel zone reduces latency, providing swift insights into dynamic transportation conditions. Additionally, this strategy improves data retrieval and accessibility, allowing analysts to access relevant datasets with ease. Partitioning enhances data security and privacy by enabling precise application of access controls and encryption measures to specific partitions. Focused analysis and decision-making are facilitated, as planners can concentrate on the characteristics and challenges of each travel zone, leading to more targeted interventions and policies. In other words, partitioning probe and sensor data by travel zone optimizes the efficiency, scalability, and responsiveness of the compute infrastructure, aligning with the specific requirements of transportation planning and analysis.

Integrating trip data across travel zones amplifies the technical benefits derived from partitioning probe and sensor data, offering a holistic understanding of transportation dynamics. This broader perspective enables comprehensive analysis, allowing planners to discern overarching trends and dependencies within and between zones. The availability of trip data across travel zones facilitates cross-zonal optimization, providing opportunities to streamline routes and coordinate traffic signals for enhanced overall transportation efficiency. The scalability of the compute infrastructure is further improved, accommodating the evolving transportation network's increased data volumes and complexities. Integrated parallel processing gains efficiency by considering relationships and dependencies between diverse zones simultaneously. Access to trip data across zones contributes to enhanced predictive modeling, aiding planners in anticipating traffic patterns not only within individual zones but also during transitions between them. Holistic resource allocation becomes possible, ensuring a balanced and efficient use of computational resources to optimize the entire transportation network. The integration of security measures is more comprehensive, with uniform application across interconnected zones, meeting data protection requirements consistently. A cross-zonal perspective on trip data informs strategic infrastructure investments, enabling planners to allocate resources strategically based on a holistic understanding of transportation needs. Overall, providing trip data across travel zones enhances the technical advantages associated with partitioning probe and sensor data, fostering a more interconnected and informed approach to transportation planning.

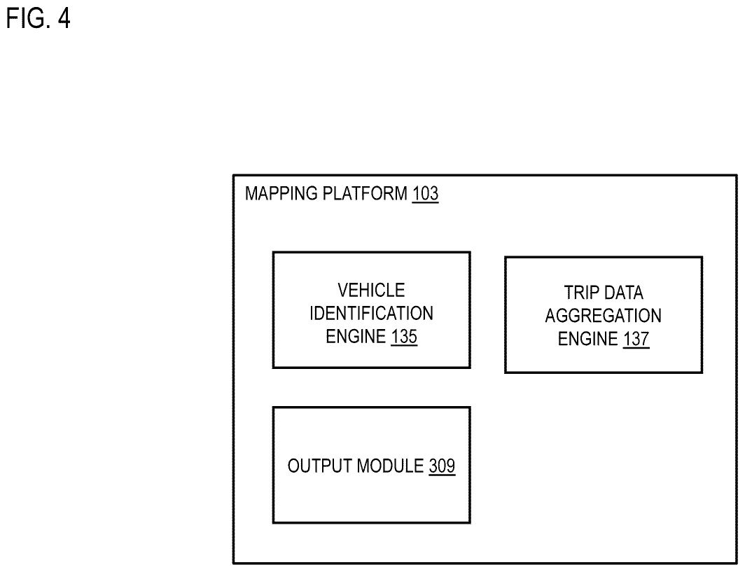

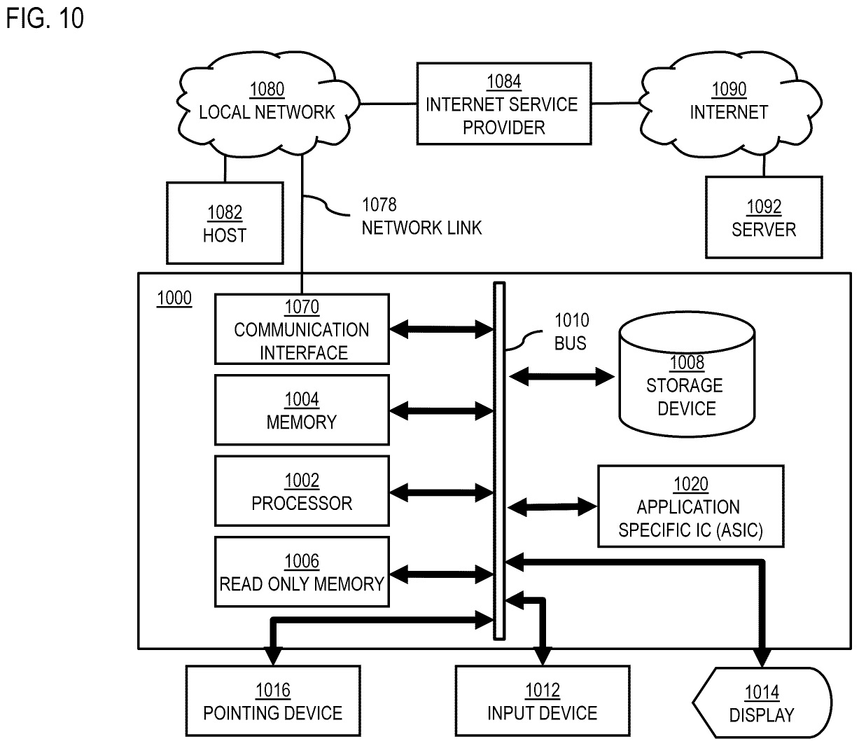

FIG. 4 is a diagram of a mapping platform 103 for providing probe vehicle analysis across travel zones, according to one example embodiment. By way of example, the mapping platform 103 includes one or more components for performing the various embodiments described herein. It is contemplated that the functions of these components may be combined or performed by other components of equivalent functionality. In one embodiment, the mapping platform 103 includes a vehicle identification engine 135, trip data aggregation engine 137, and an output module 401. The above presented modules and components of the mapping platform 103 can be implemented in hardware, firmware, software, or a combination thereof such as but not limited to the hardware illustrated in FIGS. 10-12. Though depicted as a separate entity in FIG. 1, it is contemplated that the mapping platform 103 may be implemented as a module of any of the components of the system 100 (e.g., a component of the vehicle 101, services platform 121, services 123, content providers 133, client terminal 129, application 131, etc.). In another embodiment, one or more of the modules 401-405 may be implemented as a cloud based service, local service, native application, or combination thereof. The functions of the mapping platform 103 and the modules 401-405 are discussed with respect to the figures below.

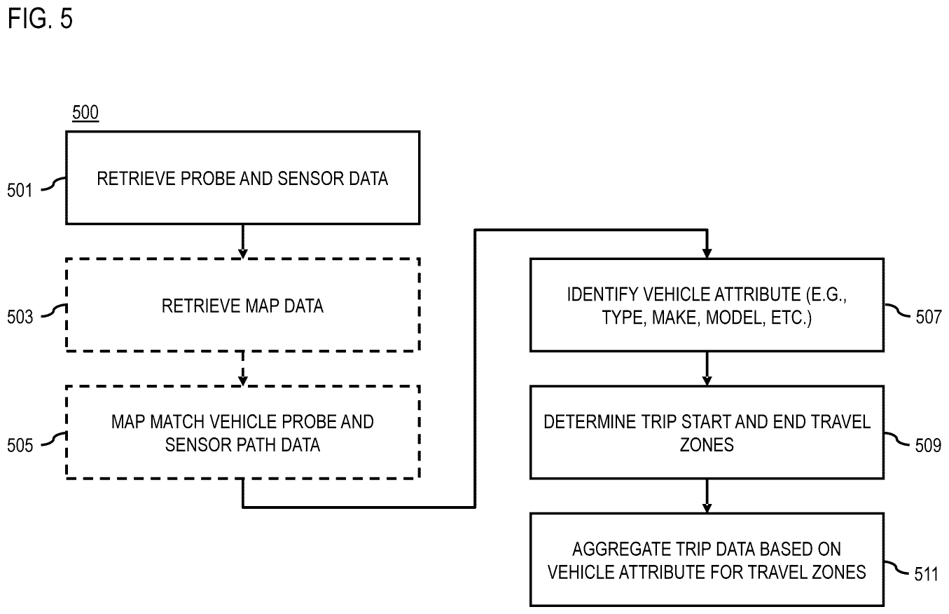

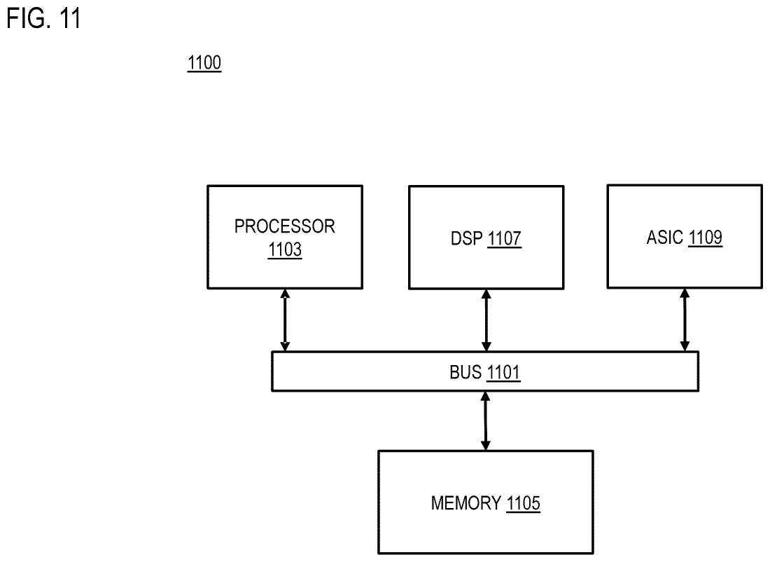

FIG. 5 is a flowchart of a process for providing probe vehicle analysis across travel zones, according to one embodiment. In various embodiments, the mapping platform 103 and/or any of the modules 401-405 of the mapping platform 103 may perform one or more portions of the process 500 and may be implemented in, for instance, a chip set including a processor and a memory as shown in FIG. 11 or in circuitry, hardware, firmware, software, or in any combination thereof. As such, the mapping platform 103 and/or the modules 401-405 can provide means for accomplishing various parts of the process 500, as well as means for accomplishing embodiments of other processes described herein in conjunction with other components of the system 100. Although the process 500 is illustrated and described as a sequence of steps, it is contemplated that various embodiments of the process 500 may be performed in any order or combination and need not include all of the illustrated steps.

In one embodiment, the various embodiment of the process 500 relates to using probe data 107, map data (e.g., geographic database 105), and/or trip data with travel mode determined for trip analysis by vehicle attribute (e.g., vehicle type-AV, EV, Gas, Diesel, vehicle make, vehicle model, etc. to support applications or services such as but not limited to T&L, TAZ planning, community growth, etc. The process 500 is described in more detail below.

In step 501, the mapping platform 103 retrieves or otherwise determines probe data, sensor data, or a combination thereof collected from a plurality of sensors of a plurality of probe vehicles traveling in a geographic area of interest. Probe data, in the context of location and position sampling, refers to a dataset comprising a sequence of location coordinates captured from a probe vehicle at a designated frequency. Essentially, it represents the continuous recording of the probe vehicle's spatial coordinates over time as it moves through a specific geographic area. The location coordinates include information such as latitude, longitude, possibly altitude, a timestamp, and an identifier to associate a sequence of the location coordinates providing a precise record of the probe vehicle's position at each sampled instance. The designated frequency determines how often these location coordinates are sampled, reflecting the temporal granularity of the data collection. For example, if the designated frequency is set to one second, the probe data will include a new set of location coordinates every second, offering a detailed and time-stamped representation of the probe vehicle's movement.

In optional step 503, the mapping platform 103 retrieves or otherwise determines map data (e.g., HD map data) associated with the geographic area of interest. In one embodiment, the map data is high-definition (HD) map data. By way of example, HD map data represents an advanced form of digital mapping designed to offer an extremely detailed and accurate depiction of the physical environment (e.g., sub-meter detail and accuracy). Tailored for applications such as autonomous vehicles and advanced driver-assistance systems (ADAS), HD maps provide a level of precision used for safe and effective navigation. These maps go beyond conventional representations by including geometrically accurate details of the road network, encompassing lane boundaries, intersections, and road curvature. HD maps offer lane-level granularity, specifying individual lanes, their widths, and designated uses, facilitating the complex decision-making processes of autonomous vehicles. Additionally, they incorporate information about traffic signs, signals, and other road infrastructure elements, supporting the interpretation and adherence to traffic regulations. HD maps also encompass essential attributes such as speed limits, road inclinations, and surface conditions, contributing to optimized vehicle speed and control, especially in diverse driving conditions. These maps play a vital role in the precise localization of vehicles within their environment, comparing real-time sensor data with the pre-mapped landscape. Furthermore, HD maps may include mechanisms for dynamic updates to reflect real-time changes in the road network, ensuring adaptability to evolving conditions.

To retrieve map data from a geographic database, the first step is to establish a connection to the database through a database management system (DBMS) or an application programming interface (API). Following this, formulate a query specifying the desired map data, encompassing criteria such as geographic coordinates, features, or attributes using SQL or a relevant query language. Execute the query to retrieve the specified map data, which may consist of various spatial elements like points, lines, polygons, along with associated attributes. After retrieval, additional steps may be taken, such as data transformation or preprocessing, to align the data with specific application requirements or standards.

In optional step 505, the mapping platform 103 map matches the vehicle path for each probe vehicle to one or more road segments based on the map data. Mapping matching the vehicle path for each probe vehicle involves aligning the trajectory and location data from the vehicle's sensors to specific road segments defined in the map data. The mapping platform 103, for instance, can use spatial indexing techniques to efficiently search for candidate road segments within the map data that closely match the location coordinates of the probe vehicle at different points in time. Techniques such as R-tree indexing or spatial hashing can expedite this process. The mapping platform 103, for instance, can use a map matching algorithm to determine the most likely road segment or segments that correspond to the observed trajectory of the probe vehicle. Various algorithms, such as Hidden Markov Models (HMM), Kalman filtering, or graph-based matching, may be employed based on the complexity of the road network and the quality of the probe data.

In step 507, the mapping platform 103 (e.g., via the vehicle identification engine 135), for each probe vehicle of the plurality of probe vehicles, determining a vehicle attribute and a vehicle path for each probe vehicle from the probe data, the sensor data, or a combination thereof. The vehicle attribute, for instance, includes but is not limited to a vehicle type, a vehicle make, a vehicle model, a vehicle year, or a combination thereof. In addition, the vehicle type can include but is not limited to an autonomous vehicle type, an electric vehicle type, a gas vehicle type, a diesel vehicle type, a hybrid vehicle type, or a combination thereof. It is contemplated that vehicle attribute can be any characteristic or property of the vehicle. In one embodiment, the vehicle identification engine 135 can extract the vehicle attribute(s) from metadata associated with the probe data or any other database indicating the attributes of the probe vehicles of interest.

In addition or alternatively, the vehicle identification engine can use machine learning models trained to classify different vehicle attributes based on the features extracted from the probe data and/or related sensor data (e.g., from cameras, lidar, radar, and/or other sensor equipped on the vehicle). For example, the sensor data may include image data which may include images or sensor readings capturing distinct vehicle features. The sensor data undergoes feature extraction to isolate key elements indicative of the vehicle's make, model, and type. Employing image processing and computer vision techniques, the engine analyzes these features and utilizes machine learning models, particularly classification algorithms such as convolutional neural networks, during a training phase. This phase refines the engine's ability to associate visual patterns with specific vehicle attributes based on labeled training data. In the operational phase, the engine applies its learned knowledge to new, unseen probe data in real-time, recognizing and inferring vehicle attributes.

In step 509, the mapping platform 103, for each probe vehicle of the plurality of probe vehicles, determines a start travel zone and an end travel zone of the vehicle path for each probe vehicle. As used herein, a travel zone or TAZ is a geographic entity, e.g., as illustrated in any of the example hierarchical categories illustrated in FIG. 2 or equivalent. For example, FIG. 2 shows the different geographic entities defined by the US Census Bureau. At the US Census Bureau, virtually all census data are geographically referenced. Currently, the standard hierarchy of census geographic entities include Census Blocks, Block Groups, Census Tracts, Counties, States, Divisions, Regions, and Nation, with some variations for the island areas and American Indian, Alaska Native, and Native Hawaiian areas. Beyond the standard geographic hierarchy, the Census Bureau uses several other geographic entities including TAZs that help support specific data uses and user groups.

In one embodiment, the size of a travel zone or TAZ can be limited to any category below a county category. A travel zone or TAZ can further be defined by its travel demand or traffic flow. Each TAZ can also be grouped by other factors like income, race, safety factors, etc. In other words, travel zones or TAZs can be categorized not only based on geographical factors but also by a range of socio-economic, demographic, safety, and vehicle-related considerations. This expanded grouping approach provides a more comprehensive understanding of transportation dynamics and enables targeted analyses. For instance, grouping travel zones by income levels allows for insights into commuting behaviors and disparities in transportation access. Demographic factors such as age, gender, and race can provide information on the preferences and needs of different population segments. Safety considerations, including traffic accident rates and crime statistics, offer insights into areas with specific safety challenges. Grouping by land use characteristics helps assess the impact of urban development on transportation infrastructure. Considering vehicle-related factors, such as vehicle type and ownership patterns, can be used for planning infrastructure to support emerging trends (e.g., EV charging infrastructure, AV services, etc.). By integrating these diverse factors, planners and policymakers can develop more nuanced and targeted transportation strategies, fostering a holistic approach beyond traditional geographic considerations.

In one embodiment, to ascertain the start and end travel zones for each vehicle within the collected probe data, a systematic approach is employed. Initially, probe data is collected, including location coordinates and timestamps, forming the basis for understanding the path of each vehicle. Spatial and temporal analyses are then applied to pinpoint the starting point of the vehicle's journey, considering both the initial location coordinates and the chronological sequence of data points. Path-tracking mechanisms (e.g., based on the map matching if performed in optional step 505) trace the vehicle's route through successive sets of location coordinates. Spatial indexing and clustering techniques efficiently group these coordinates, aiding in the identification of spatial patterns indicative of the start and end travel zones. Similar analyses are applied to determine the conclusion of the vehicle's journey. The integration of probe data with detailed map information, including road segments and intersections, enhances the precision of associating travel zones with specific geographic features. Continuous monitoring mechanisms adapt to real-time changes in the vehicle's path, ensuring dynamic responsiveness. Data validation processes refine the determination based on feedback mechanisms, addressing any anomalies in the probe data. Ultimately, the identified start and end travel zones are integrated into the overall system or application, providing valuable information for transportation planning and decision-making processes.

In step 511, the mapping platform 103 aggregates trip data based on the determined vehicles attributes for travel zones. For example, the trip data includes a trip speed, a trip time, a trip volume, or a combination thereof crossing the travel zones. In one embodiment, the aggregation is performed by processing the vehicle path for each probe vehicle to determine trip data crossing travel zones based on the start travel zone and the end travel zone. Moreover, if the option map matching of step 505 is performed, the mapping platform 103 can further determine traffic flow data, traffic volume data, or a combination thereof based on the map matching, the vehicle attribute, the start travel zone, the end travel zone, or a combination thereof. The trip data is then further based on the traffic flow data, the traffic volume data, or a combination thereof.

In one embodiment, initially, probe vehicle data, including location coordinates and timestamps, is collected and processed for vehicles traveling across travel zones. Employing map matching techniques aligns this data with the relevant travel zones, establishing a link between the vehicle's path and specific geographic areas. To determine traffic flow, the temporal sequence of vehicles passing through designated zones is analyzed, allowing for the identification of patterns, peak hours, and fluctuations in traffic density. In addition or alternatively, traffic volume is assessed by aggregating the number of vehicles traversing the travel zones over specified time intervals. Statistical analysis, such as calculating average traffic speeds and peak volume periods, enhances the insights derived from the aggregated data. In one embodiment, continuous monitoring or probe data ensures the dynamic adaptation of traffic flow and volume assessments to real-time changes.

In one embodiment, the trip data crossing travel zones is trip data that crosses between any two of the travel zones or among multiple of the travel zones. For example, trips can be categorized by origin and destination (O/D) travel zones, so that trip analysis based on vehicle attributes can be performed for different combinations of O/D travel zones of combinations of multiple travel zones.

In one embodiment, the mapping platform 103 processes the trip data to build a database table for at least one geographic entity in the geographic area of interest for storage in a cloud service. Then, the aggregating or processing to determine the trip data comprises transmitting instructions through a web services interface to initiate analysis of the database table using a scripting language. In an example development environment such as but not limited to Amazon Web Services (AWS) S3 environment using Athena tables, the travel zone or TAZ matching pipeline comprises several steps to process and analyze trips data for multiple cities The following are example steps:
1. Build Trips Database Table for Each City: Initiate the TAZ matching pipeline by creating a dedicated Database table for each city, such as Miami, Chicago, and others. This one-time setup involves defining the table schema to accommodate the required trip data.
2. Add Partitions by Year, Month, Day: Enhance the efficiency of data retrieval by partitioning the Database table based on the temporal attributes of the trips. Run a daily process to add partitions for the year, month, and day. This optimization ensures faster query performance and facilitates time-specific analysis.
3. Extract Trips Data and Calculate Attributes: Execute queries in Database to extract trips data for analysis. Calculate essential attributes like travel time and travel distance (great circle distance) from the information stored in the trips table. Generate separate output files for different providers or OEMs (e.g., different vehicle manufacturers). This process is scheduled to run regularly.
4. Download and TAZ Matching: Download the query results from cloud data storage like stored in data lake or data warehouse, and initiate TAZ matching. This involves associating trip data with Traffic Analysis Zones by geospatial matching. Assign TAZ Zone IDs to each origin-destination pair, providing a spatial context to the trips data.
5. Upload TAZ Matching Results to cloud data storage like stored in data lake or data warehouse: Upload (or otherwise output) the TAZ matching results, including Origin-Destination (O/D) pairs with associated TAZ Zone IDs, back to the cloud data storage like stored in data lake or data warehouse environment. This data becomes a resource for subsequent analysis and visualization.
6. Trips Visualization and Statistical Analysis: Leverage data visualization software tool, for example Tableau, for visualizing and analyzing the trips data. Connect to the could database tables in the cloud data storage environment using ODBC/JDBC to create interactive dashboards. Perform statistical analyses to derive insights into travel patterns, traffic density, and other relevant metrics.
7. Merge OD TAZ Zone Results with Waypoints: If further analysis with detailed waypoints is required, merge the TAZ matching results with the original waypoints data. This step enhances the granularity of the analysis and enables a more comprehensive understanding of the spatial context of trips.

It is noted that the above example with respect to an cloud environment is provided by way of illustration and not as a limitation. It is contemplated that any equivalent database environment can be used according to the various embodiments described herein.

Table 1 below illustrates pseudo trips example for TAZ O/D zones by vehicle type and make. More specifically, Table 1 shows an example of the total one-day trips from start TAZ zone to end TAZ zone categorized by vehicle type and make. The same category principle can be applied to one week, one month, one year, by querying the trip data (e.g., aggregated number of trips between each O/D) generated according to the various embodiments described herein (e.g., and stored in a database such as the geographic database 105 or equivalent). In this example, the TAZ-Start is TAZ ID number 1709742396891 and the TAZ-End is TAZ ID number 1703142516480. Trip data is aggregated according to the various embodiments described herein for the TAZ-Start/TAZ-End pair and displayed based on vehicle make (e.g., Make 1-Make 4) and vehicle type (e.g., AV, EV, Gas, Diesel). The number in each table cell is the number of trips observed in probe data collected over a period time between the TAZ-Start/TAZ-End pair.

TABLE 1

| | TAZ-End | | | | |
|---|---|---|---|---|---|
| | e.g., 1703142516480 | | | | |
| | | AV | EV | Gas | Diesel |
| TAZ-Start | Make 1 | 100 | 30 | 200 | |
| e.g., 1709742396891 | Make 2 | 110 | 20 | 230 | |
| | Make 3 | | 80 | | |
| | Make 4 | 80 | 30 | 220 | 80 |
| | . . . | | | | |
| | . . . | | | | |

In one embodiment, the mapping platform 103 partitions the probe data, the sensor data, the trip data, or a combination thereof by the travel zones. Then, the probe data, the sensor data, the trip data, or a combination thereof are processed to determine the trip data using parallelized computing based on the partitioning. For example, the mapping platform 103 organizes probe data, sensor data, trip data, or a combination thereof by splitting them into partitions based on travel zones. This division helps streamline the analysis by focusing on specific geographic areas. Using parallelized computing, the mapping platform 103 can process these partitioned datasets simultaneously, enhancing computational efficiency. This approach improves the scalability and performance of the mapping platform 103, ensuring the timely and resource-efficient analysis of extensive geospatial data for comprehensive trip analysis.

The mapping platform 103 provides the trip data as an output based on the vehicle attribute. In other words, the mapping platform 103 generates trip data as an output, organizing the information based on vehicle attributes. This output provides a structured and insightful overview of the recorded trips, allowing users to analyze and understand patterns, trends, and key metrics associated with specific vehicle attributes. Whether it's categorizing trips by vehicle type, make, or other relevant attributes, the output from the mapping platform serves as a valuable resource for informed decision-making, transportation planning, and gaining deeper insights into the dynamics of travel patterns across various vehicles.

In one embodiment, the resulting trip data from the mapping platform 103 can be stored in a database for subsequent retrieval or visualized through a user interface on a display device. This dual capability allows users to efficiently archive the valuable trip information for future reference and analysis. Moreover, the user-friendly interface on a display device facilitates real-time visualization, enabling immediate access to insights and trends derived from the trip data. For example, the mapping platform 103 or other client can render the output in a user interface of a display device to visualize the trip data crossing the travel zones.

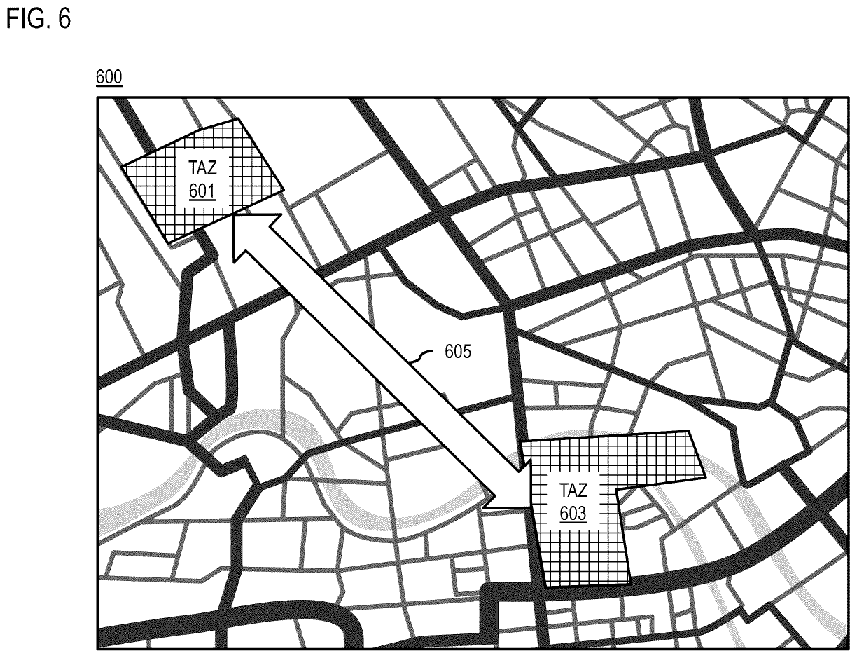

FIG. 6 is a diagram of an example trip analysis between travel zones rendered in a user interface 600, according to one example embodiment. In the example of FIG. 6, the mapping platform 103 facilitates the visualization of trip data crossing between travel zone 601 and travel zone 603 the user interface 601 as rendered on a display device (e.g., client terminal 129, vehicle 101, etc.). The user interface 600 includes user interface elements representing each travel zone 601 and 603, allowing users to interactively explore the travel dynamics. Leveraging the trip data generated according to the various embodiments described herein, such as trip volume or trip speed/time between zones, the platform renders a graphical representation, like an arrow 605, between the identified first and second travel zones. This arrow serves as a visual indicator of the travel characteristics, offering an intuitive way for users to grasp the direction, volume, or speed of trips between the specified zones. For example, the size and/or any other visual characteristic of the arrow 605 can be rendered based on the trip data. The dynamic rendering of these representations enhances the user experience, providing a clear and immediate understanding of the inter-zone travel patterns directly through the mapping platform's user interface. In one embodiment, the trip data can be represented based on vehicle attributes. For example, if a particular vehicle type (e.g., EV, AV, Gas, Diesel, etc.), make, and/or or any other vehicle attribute is selected, the user interface 600 is rendered based on data for only that type, make, and/or attribute.

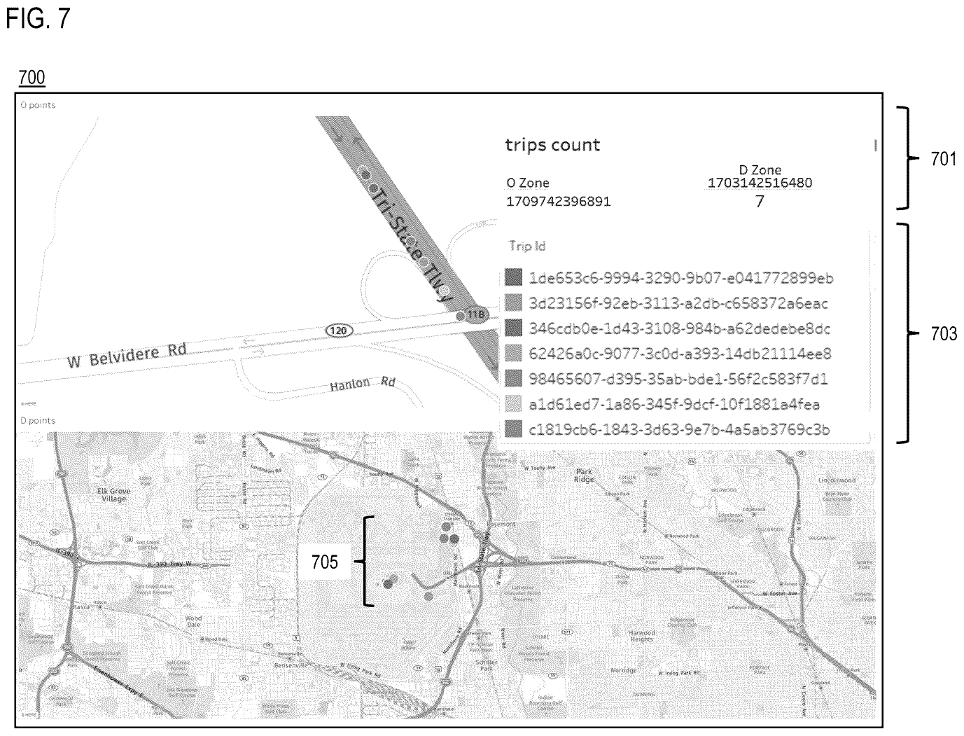

FIG. 7 is a diagram 700 of trip data for a geographic entity, according to one example embodiment. Diagram 700 is an example of another user interface or representation of trip data between O/D Taz pairs (e.g., O/D Zone pair 1709742396891 and 1703142516480 as shown). The diagram provides a trip count 701, a listing of the trips by Trip ID in user interface element 703, and a rendering of markers 705 (e.g., represented by shaded dots) to represent the location of each trip on a map display.

In one embodiment, the mapping platform 103 can build a linking database or mapping to link the travel zones to corresponding one or more map tiles of a geographic database. In this way, the mapping platform 103 can convert the trip data between the travel zones and the one or more map tiles based on the linking database. Travel zones (e.g., indicated by the zone shape file 115), in the context of the mapping platform 103, may not align with the conventional geographic divisions represented by map tiles in digital map of the geographic database 105. To bridge this distinction, the mapping platform 103 employs a strategy where it constructs a linking database or mapping. This database establishes a connection between the designated travel zones and their corresponding one or more map tiles within a geographic database. Through this linkage, the mapping platform 103 can convert and correlate trip data between the defined travel zones and the associated map tiles. This conversion is made possible by referencing the linking database, ensuring a coherent integration of trip information with the geographic representation provided by map tiles.

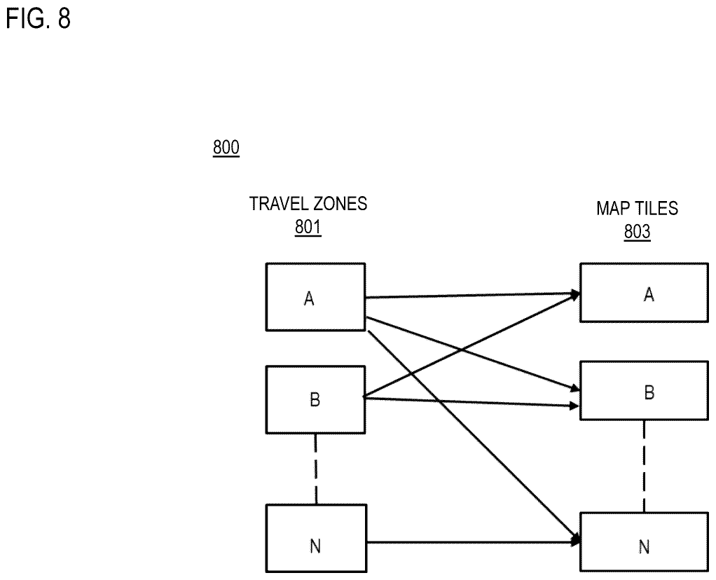

FIG. 8 is a diagram of linking mapping 800 between travel zones 801 and map tiles 803, according to one example embodiment. In this example, each travel zone 801 (e.g., marked A-N) can map to one to multiple tiles 801 (e.g., marked A-N), and vice versa. The mapping 800 shows the travel zone 801 to map tile 803 mapping relationship. For example, travel zone A covers a geographic area that includes at least portions of map tiles A, B, and N; travel zone B covers a geographic area that includes at least portions of map tiles A and B; and travel zone N covers a geographic area that includes a portion of map tile N.

In summary, in one example embodiment, the process 500 provides or facilitates probe vehicle analysis across travel zones based on one or more combinations of the following steps:
1. Retrieve map attributes, probe data, and sensor data.
2. For each probe vehicle, determine its vehicle type (e.g., AV, EV, GAS, Diesel).
3. For each probe vehicle, determine its vehicle make and model.
4. Map match the vehicle path to road segment on lane level.
5. Map match the vehicle path start and end point to TAZ zone.
6. Generate traffic flow and volume data from (1,2,3,4).
7. Generate trip data crossing TAZ zones from (6).
8. Deliver the analysis results for between any two zones or among multiple TAZ zones.

In one embodiment, the process 500 uses the vehicle identification engine 135 to process probe data 107 and sensor data 109 collected from vehicles 101 to identify the vehicle attributes (e.g., vehicle type 125, vehicle model 127, etc.) of the vehicles 101. In one embodiment, the process 500 also uses the trip data aggregation engine 137 to process the zone shape file 115 along with probe data 107 to determine trip data such as but not limited to trip volume 111, trip speed/time 113.

Returning to FIG. 1, as shown and discussed above, the system 100 includes the mapping platform 103 for providing probe vehicle analysis across travel zones. In one embodiment, the mapping platform 103 has connectivity or access to a one or more databases for storing the probe vehicle analysis across travel zones determined according to the various embodiments described herein, and as well as a geographic database 105 for retrieving map data and/or related map attributes. In one embodiment, the geographic database 105 can include electronic or digital representations of mapped geographic features to facilitate probe vehicle analysis across travel zones. In one embodiment, the mapping platform 103 has connectivity over a communication network 119 to the services platform 121 that provides one or more services 123. By way of example, the services 123 may be third-party services that rely on location-based services created or developed to use probe vehicle analysis across travel zones generated according to the various embodiments described herein. By way of example, the services 123 include, but are not limited to, autonomous/semi-autonomous vehicle operation, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 123 uses the output of the mapping platform 103.

In one embodiment, the mapping platform 103 may be a platform with multiple interconnected components. The mapping platform 103 may include multiple servers, intelligent networking devices, computing devices, components, and corresponding software for automated detection and/or characterization of road intersections. In addition, it is noted that the mapping platform 103 may be separate entities of the system 100, a part of the one or more services 123, a part of the services platform 121, or included within the vehicles 101 and/or client terminals 129.

In one embodiment, content providers 133 may provide content or data (e.g., including geographic data, 3D models, parametric representations of mapped features, etc.) to the mapping platform 103, the services platform 121, the services 123, the client terminals 129, the vehicles 101, and/or an application 131 executing on the client terminal 129. The content provided may be any type of content, such as probe data, sensor data, zone shape files, map content, textual content, audio content, video content, image content, etc. used for probe vehicle analysis across travel zones. In one embodiment, the content providers 133 may also store content associated with the mapping platform 103, geographic database 105, services platform 121, services 123, client terminal 129, and/or vehicle 101. In another embodiment, the content providers 133 may manage access to a central repository of data, and offer a consistent, standard interface to data, such as a repository of the geographic database 105.

In one embodiment, the client terminal 129 and/or vehicle 101 may execute a software application 131 to capture sensor or other observation data (e.g., observables with relative position data) for processing by mapping platform 103 according to the embodiments described herein. By way of example, the application 131 may also be any type of application that is executable on the client terminal 129 and/or vehicle 101, such as autonomous driving applications, mapping applications, location-based service applications, navigation applications, content provisioning services, camera/imaging application, media player applications, social networking applications, calendar applications, and the like. In one embodiment, the application 131 may act as a client for the mapping platform 103 and perform one or more functions associated with automated detection and/or characterization of road intersections alone or in combination with the mapping platform 103.

By way of example, the client terminal 129 is any type of computer system, embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the client terminal 129 can support any type of interface to the user (such as “wearable” circuitry, etc.). In one embodiment, the client terminal 129 may be associated with the vehicle 101 or be a component part of the vehicle 101.

In one optional embodiment, the client terminal 129 and/or vehicle 101 are configured with various sensors for generating or collecting sensor observations (e.g., for processing mapping platform 103), related geographic data, etc. In one embodiment, the sensed data represents sensor data associated with a geographic location or coordinates at which the sensor data was collected to detect point features (e.g., road objects, road signs, landmarks, etc.). In this way, the sensor data can act as observation data that can be processed to determine error in relative position data according to the various embodiments described herein. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road boundaries, road sign information, images of road obstructions, etc. for analysis), LiDAR, radar, an audio recorder for gathering audio data, velocity sensors mounted on steering wheels of the vehicles, switch sensors for determining whether one or more vehicle switches are engaged, and the like.

Other examples of optional sensors of the client terminal 129 and/or vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the client terminal 129 and/or vehicle 101 may detect the relative distance of the vehicle to a road boundary, the presence of other vehicles, pedestrians, traffic lights, potholes and any other objects, or a combination thereof. In one scenario, the sensors may detect weather data, traffic information, or a combination thereof. In one embodiment, the client terminal 129 and/or vehicle 101 may include GPS or other satellite-based receivers to obtain geographic coordinates or signal for determine the coordinates from satellites. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In another optional embodiment, the communication network 119 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), 5G New Radio networks, Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 103, services platform 121, services 123, client terminal 129, vehicle 101, and/or content providers 133 optionally communicate with each other and other components of the system 100 using well known, new or still developing protocols. In this context, a protocol includes a set of rules defining how the network nodes within the communication network 119 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

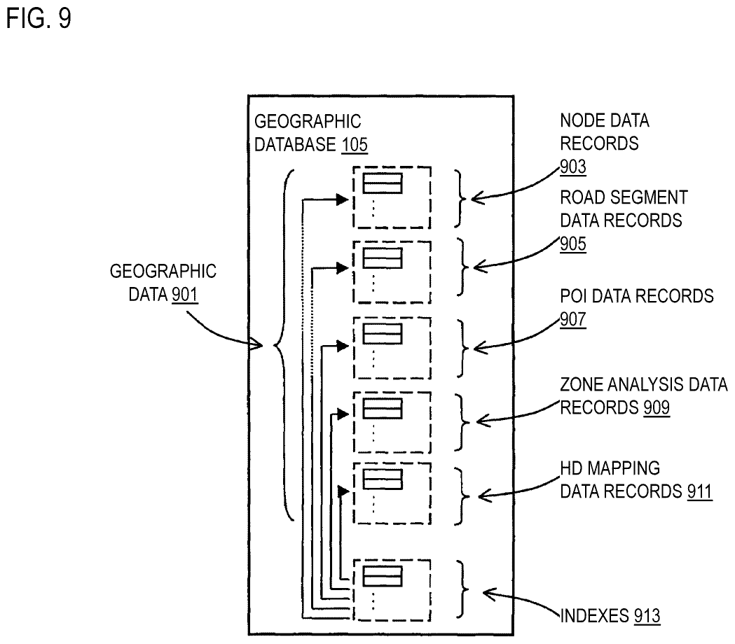

FIG. 9 is a diagram of the geographic database 105, according to one embodiment. In one embodiment, the geographic database 105 includes geographic data 901 used for (or configured to be compiled to be used for) mapping and/or navigation-related services. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 105.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 105 follows certain conventions. For example, links do not cross themselves and do not cross each other except at a node. Also, there are no duplicated shape points, nodes, or links. Two links that connect each other have a common node. In the geographic database 105, overlapping geographic features are represented by overlapping polygons. When polygons overlap, the boundary of one polygon crosses the boundary of the other polygon. In the geographic database 105, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 105 includes node data records 903, road segment or link data records 905, POI data records 907, zone analysis data records 909, other records 911, and indexes 913, for example. More, fewer, or different data records can be provided. In one embodiment, additional data records (not shown) can include cartographic (“carto”) data records, routing data, and maneuver data. In one embodiment, the indexes 913 may improve the speed of data retrieval operations in the geographic database 105. In one embodiment, the indexes 913 may be used to quickly locate data without having to search every row in the geographic database 105 every time it is accessed. For example, in one embodiment, the indexes 913 can be a spatial index of the polygon points associated with stored feature polygons.

In exemplary embodiments, the road segment data records 905 are links or segments representing roads, streets, or paths, as can be used in the calculated route or recorded route information for determination of one or more personalized routes. The node data records 903 are end points (such as intersections) corresponding to the respective links or segments of the road segment data records 905. The road link data records 905 and the node data records 903 represent a road network, such as used by vehicles, cars, and/or other entities. Alternatively, the geographic database 105 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 105 can include data about the POIs and their respective locations in the POI data records 907. The geographic database 105 can also include data about places, such as cities, towns, or other communities, and other geographic features, such as bodies of water, mountain ranges, etc. Such place or feature data can be part of the POI data records 907 or can be associated with POIs or POI data records 907 (such as a data point used for displaying or representing a position of a city).

In one embodiment, the geographic database 105 can also include zone analysis data records 909 for storing probe vehicle analysis, probe data 107, sensor data 109, vehicle attributes (e.g., vehicle type 125, vehicle model 127, etc.), zone shape file 115, trip data (e.g., trip volume 111, trip speed/time 113, etc. aggregated across travel zones by vehicle attribute), and/or any other related information/data used and/or generated according to the various embodiments described herein. In one embodiment, the zone analysis data records 909 can be associated with one or more of the node records 903, road segment records 905, and/or POI data records 907 to associate the trip data, zone data, etc. with specific geographic locations. In this way, the trip data can also be associated with the characteristics or metadata of the corresponding record 903, 905, and/or 907.

In one embodiment, the geographic database 105 can be maintained by the content provider 133 in association with the services platform 121 (e.g., a map developer). The map developer can collect geographic data to generate and enhance the geographic database 105. There can be different ways used by the map developer to collect data. These ways can include obtaining data from other sources, such as municipalities or respective geographic authorities. In addition, the map developer can employ field personnel to travel by vehicle (e.g., vehicle 101 and/or client terminal 129) along roads throughout the geographic region to observe features and/or record information about them, for example. Also, remote sensing, such as aerial or satellite photography, can be used.

The geographic database 105 can be a master geographic database stored in a format that facilitates updating, maintenance, and development. For example, the master geographic database or data in the master geographic database can be in an Oracle spatial format or other spatial format, such as for development or production purposes. Map layers may be utilized. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or client terminal 129, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing probe vehicle analysis across travel zones may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

FIG. 10 illustrates a computer system 1000 upon which an embodiment of the invention may be implemented. Computer system 1000 is programmed (e.g., via computer program code or instructions) to provide probe vehicle analysis across travel zones as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1010 includes one or more parallel conductors of information so that information is transferred quickly among devices coupled to the bus 1010. One or more processors 1002 for processing information are coupled with the bus 1010.

A processor 1002 performs a set of operations on information as specified by computer program code related to providing probe vehicle analysis across travel zones. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for providing probe vehicle analysis across travel zones. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for providing probe vehicle analysis across travel zones, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 119 for providing probe vehicle analysis across travel zones.

The term computer-readable medium is used herein to refer to any medium that participates in providing information to processor 1002, including instructions for execution. Such a medium may take many forms, including, but not limited to, non-volatile media, volatile media and transmission media. Non-volatile media include, for example, optical or magnetic disks, such as storage device 1008. Volatile media include, for example, dynamic memory 1004.

Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system can be deployed in various configurations within other computer systems, e.g., host 1082 and server 1092.

FIG. 11 illustrates a chip set 1100 upon which an embodiment of the invention may be implemented. Chip set 1100 is programmed to provide probe vehicle analysis across travel zones as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to provide probe vehicle analysis across travel zones. The memory 1105 also stores the data associated with or generated by the execution of the inventive steps.

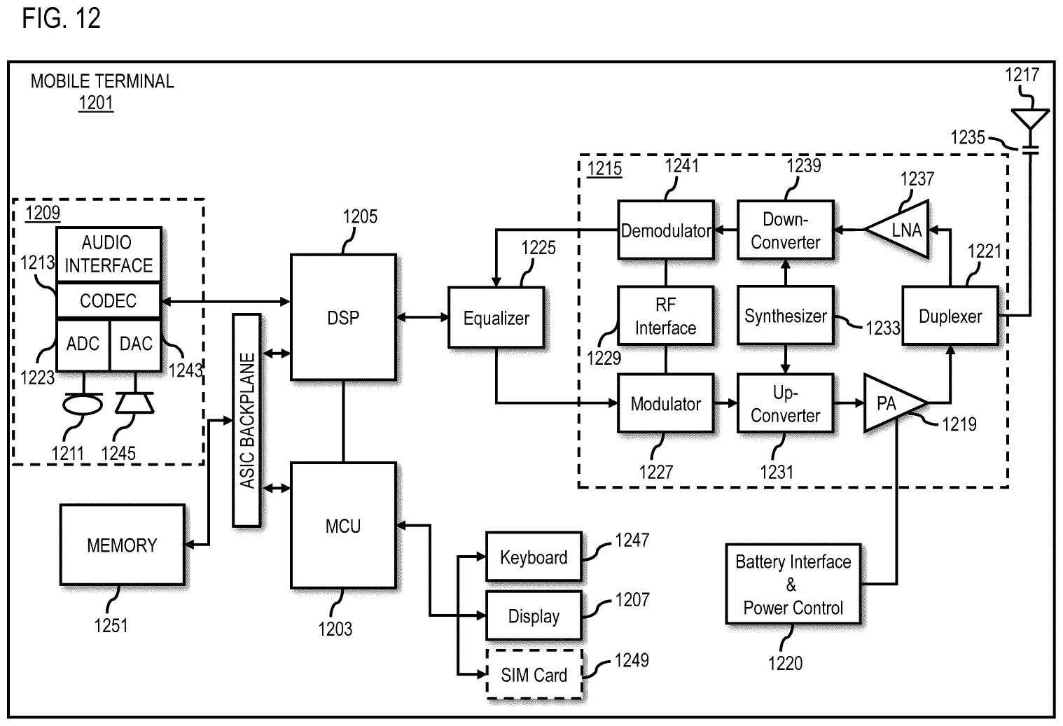

FIG. 12 is a diagram of exemplary components of a mobile terminal (e.g., handset) capable of operating in the system of FIG. 1, according to one embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile station functions that offer automatic contact matching. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile station 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile station 1201 to provide probe vehicle analysis across travel zones. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the station. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile station 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1251 may be, but not limited to, a single memory, CD, DVD, ROM, RAM, EEPROM, optical storage, or any other non-volatile or non-transitory storage medium capable of storing digital data.

An optionally incorporated SIM card 1249 carries, for instance, important information, such as the cellular phone number, the carrier supplying service, subscription details, and security information. The SIM card 1249 serves primarily to identify the mobile station 1201 on a radio network. The card 1249 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining probe data, sensor data, or a combination thereof collected from a plurality of sensors of a plurality of probe vehicles traveling in a geographic area of interest;
for each probe vehicle of the plurality of probe vehicles, determining a vehicle attribute and a vehicle path for each probe vehicle from the probe data, the sensor data, or a combination thereof, and determining a start travel zone and an end travel zone of the vehicle path for each probe vehicle;
processing the vehicle path for each probe vehicle to determine trip data crossing travel zones based on the start travel zone and the end travel zone; and
providing the trip data as an output based on the vehicle attribute.

2. The method of claim 1, wherein the trip data includes a trip speed, a trip time, a trip volume, or a combination thereof crossing the travel zones.

3. The method of claim 1, wherein the travel zones correspond to geographic zones defined by a user, a governmental authority, a regulatory authority, or a combination thereof.

4. The method of claim 1, wherein the travel zones correspond to point of interests stored in a geographic database.

5. The method of claim 1, wherein the vehicle attribute includes a vehicle type, a vehicle make, a vehicle model, a vehicle year, or a combination thereof.

6. The method of claim 5, wherein the vehicle type includes an autonomous vehicle type, an electric vehicle type, a gas vehicle type, a diesel vehicle type, a hybrid vehicle type, or a combination thereof.

7. The method of claim 1, further comprising:
determining map data associated with the geographic area of interest;
map matching the vehicle path for each probe vehicle to one or more road segments based on the map data; and
determining traffic flow data, traffic volume data, or a combination thereof based on the map matching, the vehicle attribute, the start travel zone, the end travel zone, or a combination thereof,
wherein the trip data is further based on the traffic flow data, the traffic volume data, or a combination thereof.

8. The method of claim 1, wherein the trip data crossing travel zones is trip data that crosses between any two of the travel zones or among multiple of the travel zones.

9. The method of claim 1, further comprising:
processing the trip data to build a database table for at least one geographic entity in the geographic area of interest for storage in a cloud service,
wherein the processing to determine the trip data comprises transmitting instructions through a web services interface to initiate analysis of the database table using a scripting language.

10. The method of claim 1, further comprising:
partitioning the probe data, the sensor data, the trip data, or a combination thereof by the travel zones,
wherein the probe data, the sensor data, the trip data, or a combination thereof is processed to determine the trip data using parallelized computing based on the partitioning.

11. The method of claim 1, further comprising:
rendering the output in a user interface of a display device to visualize the trip data crossing the travel zones.

12. The method of claim 1, further comprising:
building a linking database to link the travel zones to corresponding one or more map tiles of a geographic database; and
converting the trip data between the travel zones and the one or more map tiles based on the linking database.

13. An apparatus comprising:
at least one processor; and
at least one memory including computer program code for one or more programs,
the at least one memory and the computer program code configured to, with the at least one processor, cause the apparatus to perform at least the following,
determine probe data, sensor data, or a combination thereof collected from a plurality of sensors of a plurality of probe vehicles traveling in a geographic area of interest;
for each probe vehicle of the plurality of probe vehicles, determine a vehicle attribute and a vehicle path for each probe vehicle from the probe data, the sensor data, or a combination thereof, and determine a start travel zone and an end travel zone of the vehicle path for each probe vehicle;
process the vehicle path for each probe vehicle to determine trip data crossing travel zones based on the start travel zone and the end travel zone; and
provide the trip data as an output based on the vehicle attribute.

14. The apparatus of claim 13, wherein the trip data includes a trip speed, a trip time, a trip volume, or a combination thereof crossing the travel zones.

15. The apparatus of claim 13, wherein the vehicle attribute includes a vehicle type, a vehicle make, a vehicle model, a vehicle year, or a combination thereof.

16. The apparatus of claim 13, wherein the apparatus is further caused to:
determine map data associated with the geographic area of interest;
map match the vehicle path for each probe vehicle to one or more road segments based on the map data; and
determine traffic flow data, traffic volume data, or a combination thereof based on the map matching, the vehicle attribute, the start travel zone, the end travel zone, or a combination thereof,
wherein the trip data is further based on the traffic flow data, the traffic volume data, or a combination thereof.

17. A non-transitory computer-readable storage medium carrying one or more sequences of one or more instructions which, when executed by one or more processors, cause an apparatus to perform:
determining probe data, sensor data, or a combination thereof collected from a plurality of sensors of a plurality of probe vehicles traveling in a geographic area of interest;
for each probe vehicle of the plurality of probe vehicles, determining a vehicle attribute and a vehicle path for each probe vehicle from the probe data, the sensor data, or a combination thereof, and determining a start travel zone and an end travel zone of the vehicle path for each probe vehicle;
processing the vehicle path for each probe vehicle to determine trip data crossing travel zones based on the start travel zone and the end travel zone; and
providing the trip data as an output based on the vehicle attribute.

18. The non-transitory computer-readable storage medium of claim 17, wherein the trip data includes a trip speed, a trip time, a trip volume, or a combination thereof crossing the travel zones.

19. The non-transitory computer-readable storage medium of claim 17, wherein the vehicle attribute includes a vehicle type, a vehicle make, a vehicle model, a vehicle year, or a combination thereof.

20. The non-transitory computer-readable storage medium of claim 17, wherein the apparatus is caused to further perform:
determining map data associated with the geographic area of interest;
map matching the vehicle path for each probe vehicle to one or more road segments based on the map data; and
determining traffic flow data, traffic volume data, or a combination thereof based on the map matching, the vehicle attribute, the start travel zone, the end travel zone, or a combination thereof,
wherein the trip data is further based on the traffic flow data, the traffic volume data, or a combination thereof.
